(19) United States
(12) Patent Application Publication
(10) Pub. No.: US 2026/0017733 A1
(43) Pub. Date: Jan. 15, 2026

(54) SYSTEM AND METHOD FOR CONTROLLING SENSORY ENVIRONMENTS

(71) Applicant: Responsive Environments Inc., New York, NY (US)

(72) Inventor: Reese Werner Donohue, Brooklyn, NY (US)

(73) Assignee: Responsive Environments Inc., New York, NY (US)

(21) Appl. No.: 19/257,711

(22) Filed: Jul. 2, 2025

Related U.S. Application Data
(60) Provisional application No. 63/669,500, filed on Jul. 10, 2024.

(51) Int. Cl. G06Q 50/12; G06Q 10/0637; G06Q 30/01

(52) U.S. Cl. CPC G06Q 50/12; G06Q 10/0637; G06Q 30/01

(57) ABSTRACT

A system and method are provided for controlling sensory environments.

### CROSS REFERENCE TO RELATED APPLICATIONS

This application claims priority to U.S. Provisional Application No. 63/669,500 filed Jul. 10, 2025, which is herein incorporated by reference in its entirety.

### BACKGROUND OF THE DISCLOSURE

Sensory elements, such as music and lighting, are shown to have a statistically significant, double-digit impact on the performance of brick-and-mortar businesses. These elements, which can include the sensory environment of a brick-and-mortar business, impact, among other metrics, revenues, conversion rates, average order values, and occupancy rates across industries, including retail, hospitality, and commercial real estate.

The selection of music and lighting can improve or harm performance in such locations and, notably, selecting the “wrong” music is generally worse for business performance than playing no music at all. For example, field studies have shown that when a restaurant has a list of customers waiting to be seated, the restaurant can maximize its revenue by increasing turnover. Increasing the energy, volume, and intensity of the restaurant's music and lighting may cause patrons to finish their meals and leave faster so that waiting guests can be seated and served. When a restaurant has very few customers, the restaurant can maximize its revenue by increasing the average order value per table. Selecting music and lighting that creates a relaxed, cozy environment may cause patrons to stay longer and order an additional drink or dessert.

### SUMMARY

According to one aspect of the present disclosure, a computing system can include a processor and a non-transitory computer-readable storage device storing computer-executable instructions, the instructions operable to cause the processor to perform operations. The operations can include receiving performance data for a physical space, the performance data comprising point-of-sale data and occupancy data; receiving sensory environment data for the physical space, the sensory environment data comprising at least one of music data, lighting data, scent data, or climate data; receiving control data, the control data comprising weather data and one or more collection preferences of a user; generating a time-series plot comprising the performance data, the sensory environment data, and the control data; analyzing the time-series plot with an artificial intelligence model to generate one or more sensory adjustments to the physical space; and executing the one or more sensory adjustments to the physical space.

In some embodiments, analyzing the time-series plot with the artificial intelligence model to generate one or more sensory adjustments to the physical space can include identifying one or more causal relationships within the time-series plot. In some embodiments, identifying the one or more causal relationships can include predicting a causal relationship between the one or more sensory adjustments to the physical space and the performance data.

In some embodiments, receiving the performance data for the physical space can include receiving one or more of transaction information, one or more dwell times, customer traffic flow information, conversation information, and customer demographic information. In some embodiments, executing the one or more sensory adjustments to the physical space can include controlling a song selection and playback volume within the physical space. In some embodiments, executing the one or more sensory adjustments to the physical space can include controlling a scent emitted, a rate of emission of the scent, and an amount of scent emitted. In some embodiments, executing the one or more sensory adjustments to the physical space can include controlling one or more temperature settings within the physical space.

### BRIEF DESCRIPTION OF THE FIGURES

FIG. 1 is a flowchart of an example process for controlling a sensory environment according to example embodiments of the present disclosure.

FIG. 2 is an example system for processing performance data according to example embodiments of the present disclosure.

FIG. 3 is an example system for processing sensory environment data according to example embodiments of the present disclosure.

FIG. 4 is an example system for processing control data according to example embodiments of the present disclosure.

FIG. 5 is an example system that applies analytics and automation to control sensory environments according to example embodiments of the present disclosure.

FIG. 6 is an example music interface system according to example embodiments of the present disclosure.

FIG. 7 is server device that can be used within the system of FIG. 1 according to an embodiment of the present disclosure.

FIG. 8 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Despite the impact of sensory elements on a business' performance, no system exists that quantifies or optimizes the impact of the brick-and-mortar sensory environment on performance. Businesses design brick-and-mortar environments by intuition alone, without any data to guide their decisions, and, as a result, negatively impact the performance of their business with the very tools they purchase to help.

Embodiments of the present disclosure relate to a system and method for controlling a sensory environment. The disclosed system and method can, via advanced data analysis and predictive models, identify and predict the causal effects of brick-and-mortar sensory environments on various business performance metrics. In some embodiments, the disclosed system and method can utilize such insights to automatically control the sensory environment for brick-and-mortar businesses or other physical locations to drive desired outcomes. The disclosed embodiments can be applied to various retail and hospitality locations that focus on controlling music, lighting, and other parts of the sensory environment using point-of-sale, foot traffic, and other data.

In some embodiments, the disclosed system can utilize various time series data capture techniques. In particular, disclosed system can record a time series dataset that includes sensory environment conditions, such as current music conditions and current lighting conditions, in a brick-and-mortar business or other physical location. Moreover, the disclosed system can record a time series dataset that includes various performance conditions of a brick-and-mortar business, such as time of individual transactions, dollar amounts of each transaction, items per transaction, dwell times, customer traffic flow, conversion rates, and customer demographics. Such data can also be recorded as abstractions rather than specific data. For example, an entity can release its occupancy data on a scale from 1-5 rather than providing the exact number of customers on site. In addition, the disclosed system can record a time series dataset that includes control conditions for a brick-and-mortar business, such as weather, time of day, day of week, month, physical space characteristics, product mix, customer demographics, customer preferences, location, online brand engagement, marketing intelligence, and online references.

In some embodiments, the disclosed system can utilize enriched sensory environment metadata generation. For example, the system can assign musicological, cultural, and contextual metadata to music conditions. For example, the system can assign the tempo, genre, key, modality, loudness, volume, popularity, instrumental-ness, mood, energy, danci-ness, lyrical content, cultural references, press review analysis, online engagement, social media references to music conditions. In addition, the system can assign metadata to lighting conditions, such as the type, number, and position of lights, lumens, and hues.

In some embodiments, the disclosed system can utilize predictive analysis and modeling. For example, the system can use the above-described data to train an artificial intelligence (AI) model capable of identifying and predicting causal relationships among the data. For example, the model can identify instances of a particular genre increasing conversion rates. Moreover, given a set of sensory environment and control conditions, the model can predict the performance conditions of a business. In one particular example, the model could determine that, on sunny Thursday afternoons, a certain entity has a 95% probability of increasing conversion rates 1.3%-2.3% above historical averages by playing music with a tempo of 90-112 BPM and an emotional valence of 67% or higher.

In some embodiments, the disclosed system can be automated. In particular, using the aforementioned predictive AI model, the system can automatically control the sensory environment of an entity's physical location, such as a brick-and-mortar store. For example, the system can identify a song with characteristics that can improve conversion under given conditions and automatically queue that song for playback in the business. Another example is that the system can identify that, for a certain time of day during a certain season, adjusting the temperature and brightness of the spot lighting over a particular product yields an increase in sales of that product.

In some embodiments, the disclosed system can utilize recursive improvement to improve its performance, accuracy, and predictive capabilities over time. For example, the system can continually perform A/B tests and use the results to continually improve its predictive model. In addition, the system can recursively improve its predictive model by comparing predicted results with actual results and refining its predictive capabilities to match actual outcomes.

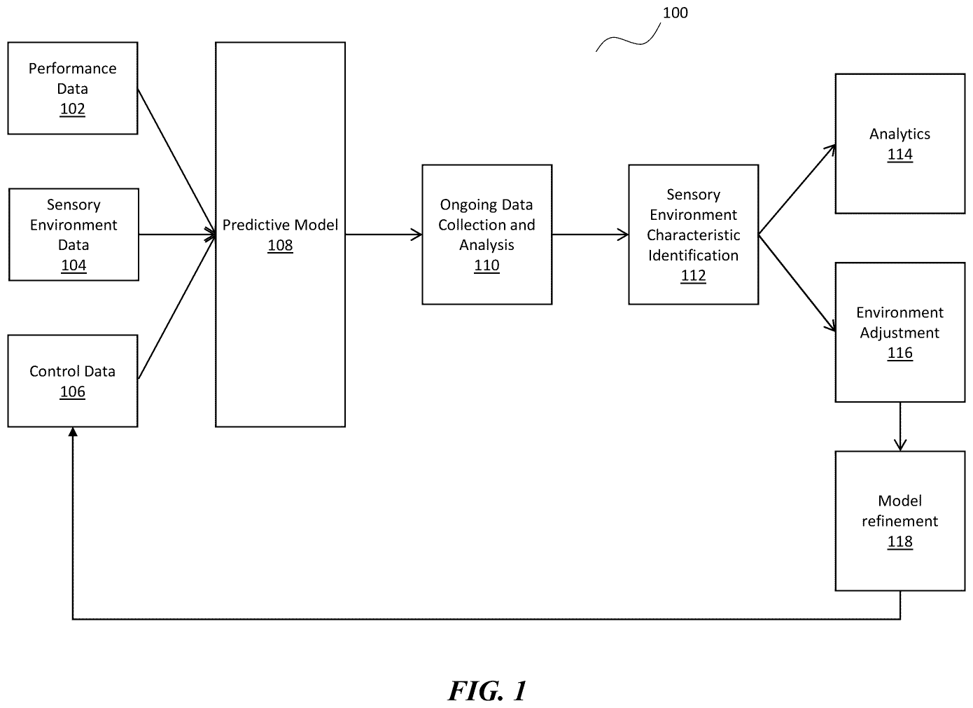

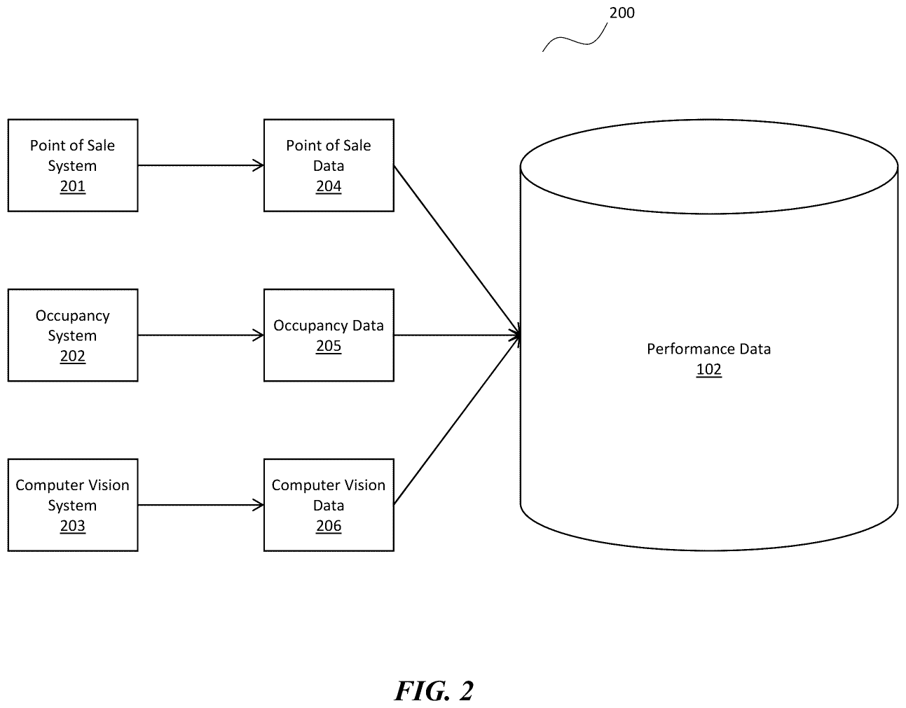

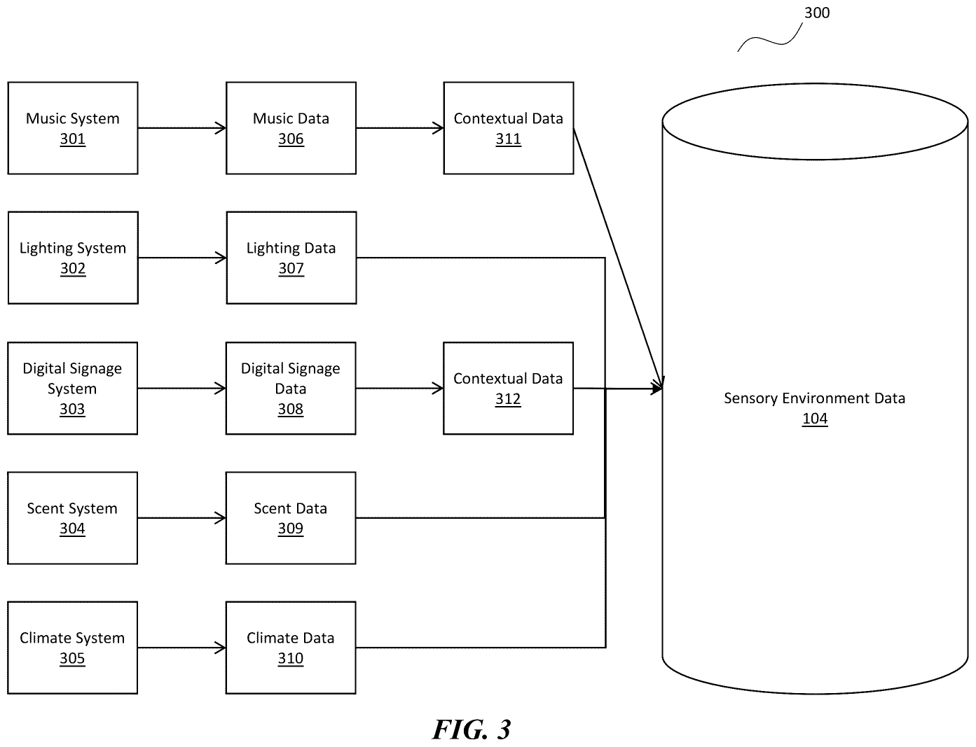

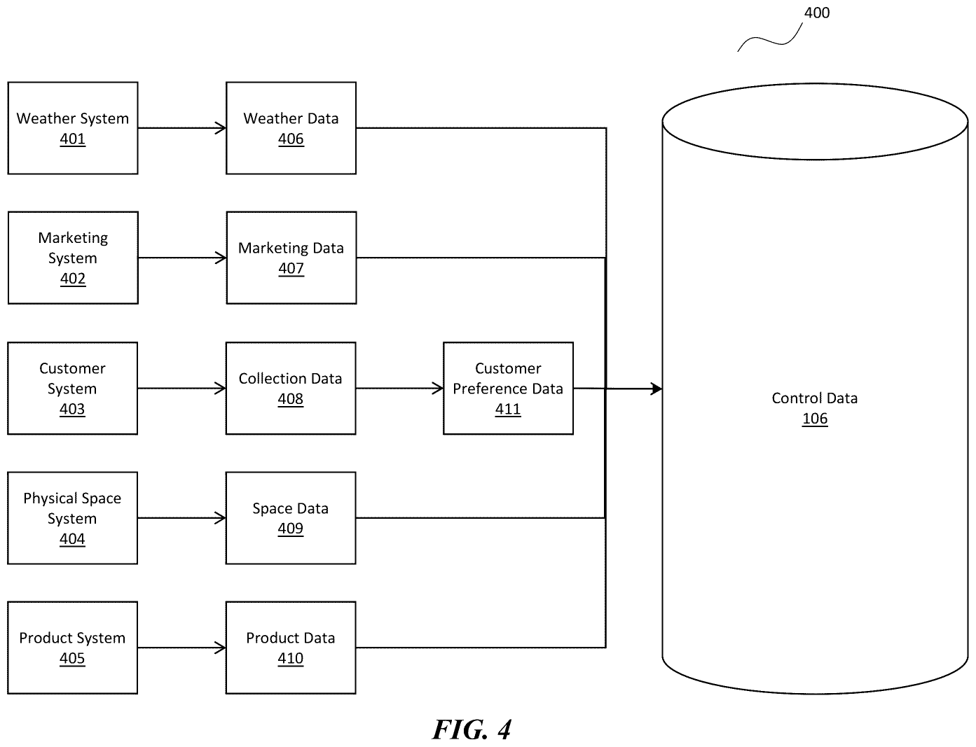

FIG. 1 is a flowchart of an example process 100 for controlling a sensory environment according to example embodiments of the present disclosure. At block 102, the system can receive performance data which can include data about a business or physical environment. Additional details with respect to performance data are described in FIG. 2. At block 104, the system can receive sensory environment data about a physical environment. Additional details with respect to sensory environment data are described in FIG. 3. At block 106, the system can receive control data about a physical environment. Additional details with respect to control data are described in FIG. 4. At block 108, a predictive model can record the aforementioned data in a time series dataset. In addition, the predictive model can calibrate a predictive model for the particular set of data (i.e., for a certain entity's physical location).

At block 110, ongoing data and collection and analysis can be performed. For example, performance, sensory environment, and control data from blocks 102-106 can continue to enter the predictive model in real-time on an ongoing basis. At block 112, sensory environment characteristic identification can be performed. For example, taking into account real-time conditions, the predictive model can identify the sensory environment characteristics that are most likely to have an impact on performance outcomes of the business associated with the physical environment. At block 114, the predictive model can surface insights as both real-time and historical analytics. At block 116, the predictive model can dynamically adjust the characteristics of the sensory environment to achieve a desired outcome. At block 118, refinement of the predictive model can be performed. For example, the predicted and actual outcomes can be recorded and used to refine the calibration of the predictive model. In addition, the model refinements can be fed back to the control data at 106.

FIG. 2 is an example system 200 for processing performance data according to example embodiments of the present disclosure. In some embodiments, the system 200 can include a point-of-sale system 201, an occupancy system 202, and a computer vision system 203. In some embodiments, the point-of-sale system 201 can collect data via an application programming interface (API) integration with a point-of-sale system or a manual input. Then, the point-of-sale system 201 can feed point-of-sale data 204 to the performance data center 102. In some embodiments, point-of-sale data 204 can include, but is not limited to, time of transaction, dollar amount of transaction, items per order, individual item SKUs, category of each item purchased, descriptors of each item purchased, context of each item purchased, and information about customer purchase history. In addition, the occupancy system 202 can collect data via an API integration with a foot traffic or other occupancy system or via manual input. Then, the occupancy system 202 can feed occupancy data 205 to the performance data center 102. In some embodiments, occupancy data 205 can include, but is not limited to, time of customer entry, time of customer exit, dwell time for each customer, average dwell time, number of occupants, space capacity, average space utilization, and current space utilization. In addition, the computer vision system 203 can collect data via an API integration with a computer vision system or a manual input. Then, the computer vision system 203 can feed computer vision data 206 to the performance data center 102. In some embodiments, the computer vision data 206 can include, but is not limited to, customer sentiment via facial recognition, product engagement, traffic flow, and a unique identifier for each customer.

FIG. 3 is an example system 300 for processing sensory environment data according to example embodiments of the present disclosure. In some embodiments, the system 300 can include a music system 301, a lighting system 302, a digital signage system 303, a scent system 304, and a climate system 305. In some embodiments, the music system 301 can collect music data via integration with a music streaming service API. Then, the music system 301 can feed music data 306 and contextual data 311 to the sensory environment data center 104. In some embodiments, music data 306 can include, but is not limited to, tempo, genre, key, modality, loudness, volume, popularity, instrumental-ness, mood, energy, artist, song, album, and danci-ness. In addition, the contextual data 311 can include additional music data captured via integration with additional third-party services or directly from the Internet, such as lyrical content, cultural references, press review analysis, online engagement, social media references.

In some embodiments, the lighting system 302 can collect data with an API integration with various lighting systems. Then, the lighting system 302 can feed lighting data 307 to the sensory environment data center 104. In some embodiments, lighting data 307 can include, but is not limited to, hue, brightness, temperature, type of light source, location of light source, and number of light sources. In some embodiments, the digital signage system 303 can capture data via an API integration with various signage systems. Then, the digital signage system 303 can feed digital signage data 308 and contextual data 312 to the sensory environment data center 104. In some embodiments, the digital signage data 308 can include, but is not limited to, type of content, content characteristics, content representation, content creator, display characteristics, display location, and number of displays. In addition, the contextual data 312 can include additional video and image data captured via integration with additional third-party services or directly from the Internet, such as lyrical content, cultural references, press review analysis, online engagement, and social media references. In some embodiments, the contextual data 312 can include displayed content from brand advertisements (e.g., a toothpaste ad in a pharmacy store). For example, a computer vision system can view a user in a sporting goods store looking at skis in one section of the store, and then digital signage in a different area of the stored could display winter, ski, or other outdoor accessory content. In addition, in some embodiments, facial recognition technology can be applied to identify and track individuals' movement within a physical environment and correlate environment adjustments.

In some embodiments, the scent system 304 can capture scent data with an API integration with various scent systems. Then, the scent system 304 can feed scent data 309 to the sensory environment data center 104. In some embodiments, scent data can include, but is not limited to, type of scent, amount emitted, intensity of scent, and space saturation.

In some embodiments, the climate system 305 can capture climate data with an API integration with various climate systems. Then, the climate system 305 can feed climate data 310 to the sensory environment data center 104. In some embodiments, climate data can include, but is not limited to, temperature and humidity.

FIG. 4 is an example system 400 for processing control data according to example embodiments of the present disclosure. In some embodiments, the system 400 can include a weather system 401, a marketing system 402, a customer system 403, a physical space system 404, and a product system 405. In some embodiments, the weather system 401 can collect weather data via integration with a weather service API. Then, the weather system 401 can feed weather data 406 to the control data center 106. In some embodiments, the weather data 406 can include, but is not limited to, temperature, precipitation, cloud cover, and humidity. In some embodiments, the marketing system 402 can collect marketing data via integration with a CRM or equivalent system. Then, the marketing system 402 can feed marketing data 407 to the control data center 106. In some embodiments, the marketing data 407 can include, but is not limited to, recent marketing campaigns, social media mentions, brand search history, and other e-Commerce customer data.

In some embodiments, the customer system 403 can collect customer preference data via integration with a customer-facing interface, such as JukeBox or any other customer-facing, guest-facing, or public-facing mobile experience that allows users to interact with and influence a larger system. Then, the customer system 403 can feed collection data 408 to the control data center 106. In some embodiments, the collection data 408 can be captured via direct input by customers or by integrating with a user's third-party service. In addition, customer preference data 411 can include, but is not limited to, listening history from music streaming services, light settings on third lighting control apps, and visual content history from image and video system.

In some embodiments, the physical space system 404 can collect data from the physical space in which the system is located. Then, the physical space system 404 can feed space data 409 to the control data center 106. In some embodiments, space data 409 can include, but is not limited to, square footage, location, number of floors, system design (e.g., register placement), product mix location (i.e., location of pants, shirts, and other products), and layout.

In some embodiments, the product system 405 can collect product data via an API integration with a supply chain and merchandising system. Then, the product system 405 can feed product data 410 to the control data center 106. In some embodiments, product data can include, but is not limited to, types of products, product mix, and product release dates.

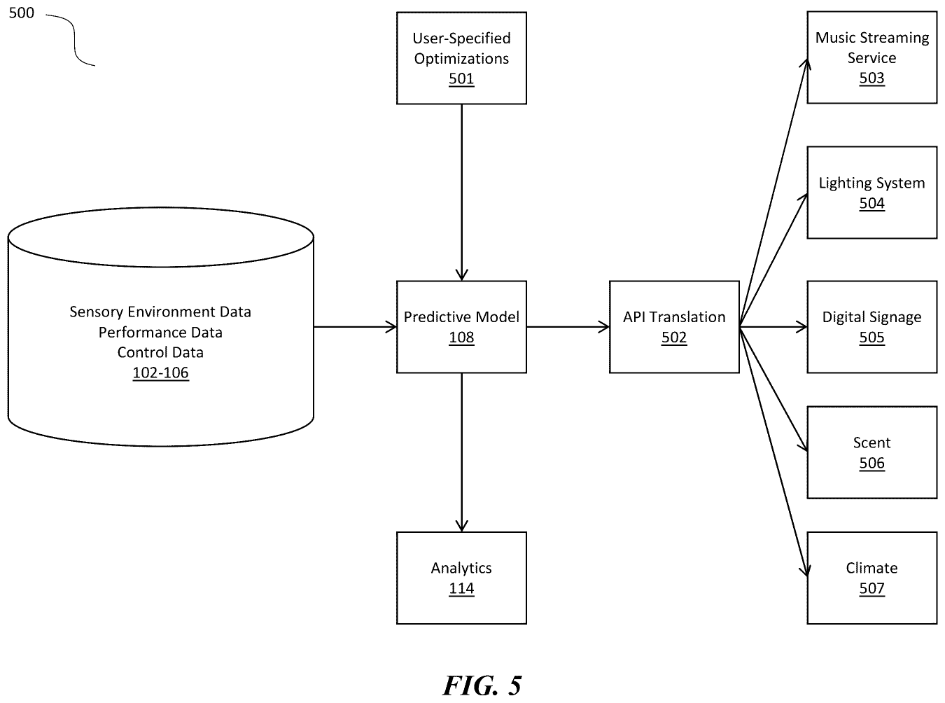

FIG. 5 is an example system 500 that applies analytics and automation to control sensory environments according to example embodiments of the present disclosure. In some embodiments, as discussed above, the predictive model 108 can be trained on various data 102-106. The predictive model 108 can be trained to analyze real-time conditions and determine how to optimize sensory environment to drive one or more performance metrics. In addition, system 600 can allow for a user-specified optimization 501 with the predictive model 108. For example, the user-specified optimization 501 can rank the one or more performance metrics the predictive model 108 should optimize when controlling the sensory environment. In addition, the system 500 can include an API translation 502, which can translate the predictive model 108's optimizations into API calls that integrate with different sensory element systems to control their conditions. For example, the API translation 502 can integrate with a music streaming service 503 to control song selection and playback volume; a lighting system 504 to control brightness, hue, and temperature; a digital signage system 505 to control content selection and playback and display settings; scents 506 to control the type of scent emitted, rate of emission, and amount emitted; and climate 507 to control temperature settings and air conditioning. In addition, the predictive model 108 can provide various analytics 114, which can translate the predictive model to easily digestible insights for users to understand the causal relationships between sensory environment and performance.

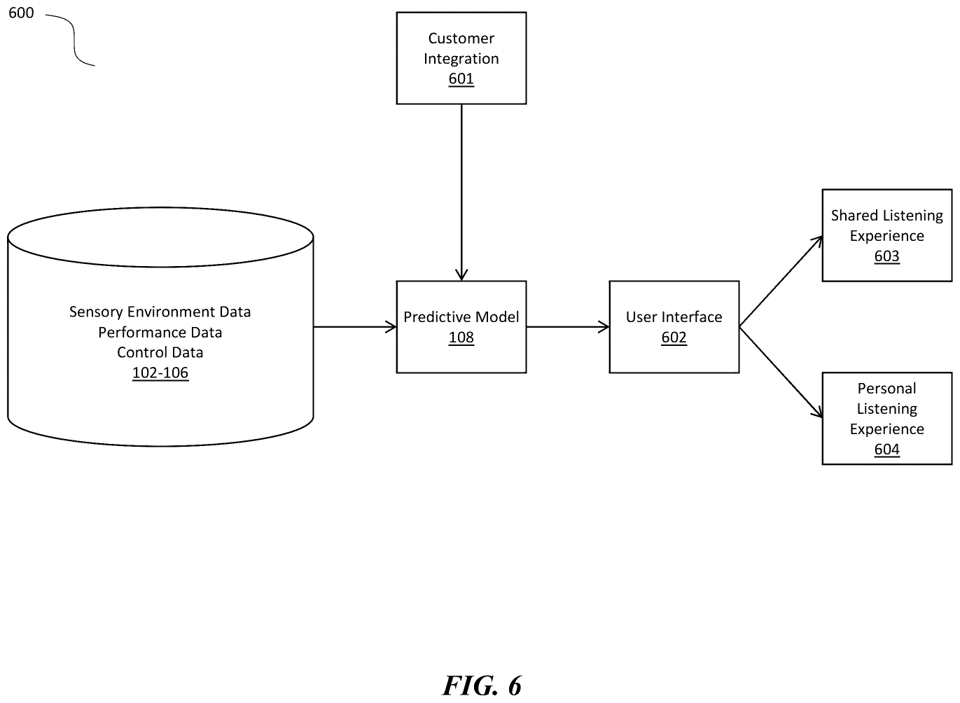

FIG. 6 is an example music interface system 600 according to example embodiments of the present disclosure. In some embodiments, as discussed above, the predictive model 108 can be trained on various data 102-106. The predictive model 108 can be trained to analyze real-time conditions and determine how to optimize sensory environment to drive one or more performance metrics. In addition, the predictive model 108 can cross-reference customer preferences and define song lists that fit certain criteria. In addition, the system 600 can allow for customer integration 601 with the predictive model 108. In addition, various outputs from the predictive model 108 can be output to a user interface 602. In some embodiments, a user can be presented with the option to soundtrack a shared space (e.g., Jukebox) or launch a personal listening experience, such as a playlist created from the predictive model 108's recommendation algorithm. Finally, the user interface 602 can be integrated with a shared listening experience 603 and a personal listening experience 604. In some embodiments, the shared listening experience 603 can control music in shared spaces via API integration with commercial music streaming service to control song selection and playback. In some embodiments, song selection can be determined by aggregate interactions of users in the space. In some embodiments, the personal listening experience 604 can generate playlists for personal listening with the business's curatorial point of view as the guiding song list. In addition, the personal listening experience 604 can control personal music streaming service to control song selection and playback.

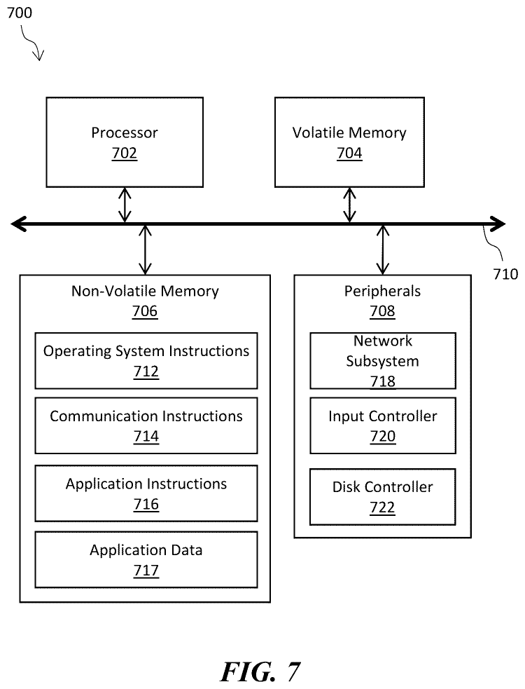

FIG. 7 is a diagram of an example server device 700 that can be used within the disclosed systems. Server device 700 can implement various features and processes as described herein. Server device 700 can be implemented on any electronic device that runs software applications derived from compiled instructions, including without limitation personal computers, servers, smart phones, media players, electronic tablets, game consoles, email devices, etc. In some implementations, server device 700 can include one or more processors 702, volatile memory 704, non-volatile memory 706, and one or more peripherals 708. These components can be interconnected by one or more computer buses 710.

Processor(s) 702 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 710 can be any known internal or external bus technology, including but not limited to ISA, EISA, PCI, PCI Express, USB, Serial ATA, or FireWire. Volatile memory 704 can include, for example, SDRAM. Processor 702 can receive instructions and data from a read-only memory or a random access memory or both. Essential elements of a computer can include a processor for executing instructions and one or more memories for storing instructions and data.

Non-volatile memory 706 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 706 can store various computer instructions including operating system instructions 712, communication instructions 714, application instructions 716, and application data 717. Operating system instructions 712 can include instructions for implementing an operating system (e.g., Mac OS®, Windows®, or Linux). The operating system can be multi-user, multiprocessing, multitasking, multithreading, real-time, and the like. Communication instructions 714 can include network communications instructions, for example, software for implementing communication protocols, such as TCP/IP, HTTP, Ethernet, telephony, etc. Application instructions 716 can include instructions for various applications. Application data 717 can include data corresponding to the applications.

Peripherals 708 can be included within server device 700 or operatively coupled to communicate with server device 700. Peripherals 708 can include, for example, network subsystem 718, input controller 720, and disk controller 722. Network subsystem 718 can include, for example, an Ethernet of WiFi adapter. Input controller 720 can be any known input device technology, including but not limited to a keyboard (including a virtual keyboard), mouse, track ball, and touch-sensitive pad or display. Disk controller 722 can include one or more mass storage devices for storing data files; such devices include magnetic disks, such as internal hard disks and removable disks; magneto-optical disks; and optical disks.

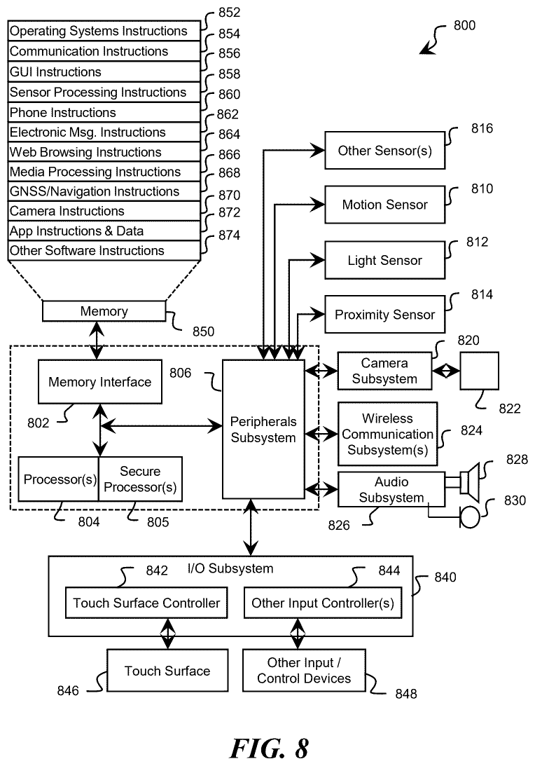

FIG. 8 is an example computing device that can be used within the disclosed systems, according to an embodiment of the present disclosure. The illustrative user device 800 can include a memory interface 802, one or more data processors, image processors, central processing units 804, and or secure processing units 805, and peripherals subsystem 806. Memory interface 802, one or more central processing units 804 and or secure processing units 805, and or peripherals subsystem 806 can be separate components or can be integrated in one or more integrated circuits. The various components in user device 800 can be coupled by one or more communication buses or signal lines.

Sensors, devices, and subsystems can be coupled to peripherals subsystem 806 to facilitate multiple functionalities. For example, motion sensor 810, light sensor 812, and proximity sensor 814 can be coupled to peripherals subsystem 806 to facilitate orientation, lighting, and proximity functions. Other sensors 816 can also be connected to peripherals subsystem 806, such as a global navigation satellite system (GNSS) (e.g., GPS receiver), a temperature sensor, a biometric sensor, magnetometer, or other sensing device, to facilitate related functionalities.

Camera subsystem 820 and optical sensor 822, e.g., a charged coupled device (CCD) or a complementary metal-oxide semiconductor (CMOS) optical sensor, can be utilized to facilitate camera functions, such as recording photographs and video clips. Camera subsystem 820 and optical sensor 822 can be used to collect images of a user to be used during authentication of a user, e.g., by performing facial recognition analysis.

Communication functions can be facilitated through one or more wired and or wireless communication subsystems 824, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 824. The specific design and implementation of communication subsystems 824 can depend on the communication network(s) over which the user device 800 is intended to operate. For example, user device 800 can include communication subsystems 824 designed to operate over a GSM network, a GPRS network, an EDGE network, a WiFi or WiMax network, and a Bluetooth™ network. For example, wireless communication subsystems 824 can include hosting protocols such that device 800 can be configured as a base station for other wireless devices and or to provide a WiFi service.

Audio subsystem 826 can be coupled to speaker 828 and microphone 830 to facilitate voice-enabled functions, such as speaker recognition, voice replication, digital recording, and telephony functions. Audio subsystem 826 can be configured to facilitate processing voice commands, voice-printing, and voice authentication, for example.

I/O subsystem 840 can include a touch-surface controller 842 and or other input controller(s) 844. Touch-surface controller 842 can be coupled to a touch-surface 846. Touch-surface 846 and touch-surface controller 842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 846.

The other input controller(s) 844 can be coupled to other input/control devices 848, such as one or more buttons, rocker switches, thumb-wheel, infrared port, USB port, and or a pointer device such as a stylus. The one or more buttons (not shown) can include an up/down button for volume control of speaker 828 and or microphone 830.

In some implementations, a pressing of the button for a first duration can disengage a lock of touch-surface 846; and a pressing of the button for a second duration that is longer than the first duration can turn power to user device 800 on or off. Pressing the button for a third duration can activate a voice control, or voice command, module that enables the user to speak commands into microphone 830 to cause the device to execute the spoken command. The user can customize a functionality of one or more of the buttons. Touch-surface 846 can, for example, also be used to implement virtual or soft buttons and or a keyboard.

In some implementations, user device 800 can present recorded audio and or video files, such as MP3, AAC, and MPEG files. In some implementations, user device 800 can include the functionality of an MP3 player, such as an iPod™. User device 800 can, therefore, include a 36-pin connector and or 8-pin connector that is compatible with the iPod. Other input/output and control devices can also be used.

Memory interface 802 can be coupled to memory 850. Memory 850 can include high-speed random access memory and or non-volatile memory, such as one or more magnetic disk storage devices, one or more optical storage devices, and or flash memory (e.g., NAND, NOR). Memory 850 can store an operating system 852, such as Darwin, RTXC, LINUX, UNIX, OS X, Windows, or an embedded operating system such as VxWorks.

Operating system 852 can include instructions for handling basic system services and for performing hardware dependent tasks. In some implementations, operating system 852 can be a kernel (e.g., UNIX kernel). In some implementations, operating system 852 can include instructions for performing voice authentication.

Memory 850 can also store communication instructions 854 to facilitate communicating with one or more additional devices, one or more computers and or one or more servers. Memory 850 can include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic messaging-related process and functions; web browsing instructions 864 to facilitate web browsing-related processes and functions; media processing instructions 866 to facilitate media processing-related functions and processes; GNSS/Navigation instructions 868 to facilitate GNSS and navigation-related processes and instructions; and or camera instructions 870 to facilitate camera-related processes and functions.

Memory 850 can store application (or “app”) instructions and data 872, such as instructions for the apps described above in the context of FIGS. 1-6. Memory 850 can also store other software instructions 874 for various other software applications in place on device 800. The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computing system comprising:
a processor; and
a non-transitory computer-readable storage device storing computer-executable instructions, the instructions operable to cause the processor to perform operations comprising:
receiving performance data for a physical space, the performance data comprising point-of-sale data and occupancy data;
receiving sensory environment data for the physical space, the sensory environment data comprising at least one of music data, lighting data, scent data, or climate data;
receiving control data, the control data comprising weather data and one or more collection preferences of a user;
generating a time-series plot comprising the performance data, the sensory environment data, and the control data;
analyzing the time-series plot with an artificial intelligence model to generate one or more sensory adjustments to the physical space; and
executing the one or more sensory adjustments to the physical space.

2. The computing system of claim 1, wherein analyzing the time-series plot with the artificial intelligence model to generate one or more sensory adjustments to the physical space comprises identifying one or more causal relationships within the time-series plot.

3. The computing system of claim 2, wherein identifying the one or more causal relationships comprises predicting a causal relationship between the one or more sensory adjustments to the physical space and the performance data.

4. The computing system of claim 1, wherein the operations comprise:
receiving sentiment data from a computer vision system associated with the physical space; and
generating the one or more sensory adjustments to the physical space based at least in part on the sentiment data.

5. The computing system of claim 1, wherein executing the one or more sensory adjustments to the physical space comprises controlling a song selection and playback volume within the physical space.

6. The computing system of claim 5, wherein controlling the song selection and playback volume within the physical space comprises generating one or more real-time music compositions based on current performance, sentiment, and environmental data.

7. The computing system of claim 1, wherein executing the one or more sensory adjustments to the physical space comprises controlling a scent emitted, a rate of emission of the scent, and an amount of scent emitted.

8. The computing system of claim 1, wherein executing the one or more sensory adjustments to the physical space comprises controlling one or more temperature settings within the physical space.

9. The computing system of claim 1, wherein executing the one or more sensory adjustments to the physical space comprises controlling one or more of a hue, brightness, temperature, or saturation of light sources within the physical space. receiving the performance data for the physical space comprises receiving one or more of transaction information, one or more dwell times, customer traffic flow information, conversation information, and customer demographic information.

10. The computing system of claim 1, wherein receiving the performance data for the physical space comprises receiving one or more of transaction information, one or more dwell times, customer traffic flow information, conversation information, and customer demographic information.

11. A computer-implemented method comprising:
receiving performance data for a physical space, the performance data comprising point-of-sale data and occupancy data;
receiving sensory environment data for the physical space, the sensory environment data comprising at least one of music data, lighting data, scent data, or climate data;
receiving control data, the control data comprising weather data and one or more collection preferences of a user;
generating a time-series plot comprising the performance data, the sensory environment data, and the control data;
analyzing the time-series plot with an artificial intelligence model to generate one or more sensory adjustments to the physical space; and
executing the one or more sensory adjustments to the physical space.

12. The computer-implemented method of claim 11, wherein analyzing the time-series plot with the artificial intelligence model to generate one or more sensory adjustments to the physical space comprises identifying one or more causal relationships within the time-series plot.

13. The computer-implemented method of claim 12, wherein identifying the one or more causal relationships comprises predicting a causal relationship between the one or more sensory adjustments to the physical space and the performance data.

14. The computer-implemented method of claim 11, comprising:
receiving sentiment data from a computer vision system associated with the physical space; and
generating the one or more sensory adjustments to the physical space based at least in part on the sentiment data.

15. The computer-implemented method of claim 11, wherein executing the one or more sensory adjustments to the physical space comprises controlling a song selection and playback volume within the physical space.

16. The computer-implemented method of claim 11, wherein executing the one or more sensory adjustments to the physical space comprises controlling a scent emitted, a rate of emission of the scent, and an amount of scent emitted.

17. The computer-implemented method of claim 11, wherein executing the one or more sensory adjustments to the physical space comprises controlling one or more temperature settings within the physical space.

18. The computer-implemented method of claim 11, wherein executing the one or more sensory adjustments to the physical space comprises controlling one or more temperature settings within the physical space.

19. The computer-implemented method of claim 11, wherein executing the one or more sensory adjustments to the physical space comprises controlling one or more of a hue, brightness, temperature, or saturation of light sources within the physical space. receiving the performance data for the physical space comprises receiving one or more of transaction information, one or more dwell times, customer traffic flow information, conversation information, and customer demographic information.

20. The computer-implemented method of claim 11, wherein receiving the performance data for the physical space comprises receiving one or more of transaction information, one or more dwell times, customer traffic flow information, conversation information, and customer demographic information.
